(19) United States
(12) Patent Application Publication
(10) Pub. No.: US 2004/0210440 A1
(43) Pub. Date: Oct. 21, 2004

(54) Efficient implementation for joint optimization of excitation and model parameters with a general excitation function

(76) Inventors: Khosrow Lashkari, Fremont, CA (US); Toshio Miki, Yokohama (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/678,247

(22) Filed: Oct. 3, 2003

Related U.S. Application Data
(60) Provisional application No. 60/422,928, filed on Nov. 1, 2002.
(60) Provisional application No. 60/434,513, filed on Dec. 17, 2002.

(51) Int. Cl. G10L 13/00

(52) U.S. Cl. 704/264

(57) ABSTRACT

A method and apparatus for generating excitation and model parameters in source filter models are described. In one embodiment, the method comprises generating synthesized speech samples, using a synthesis filter, in response to an excitation signal, determining a synthesis error between original speech samples and the synthesized speech sample and substantially reducing the synthesis error by computing both the excitation signal and filter parameters for the synthesis filter. The substantial reduction in the synthesis error is performed by applying a gradient descent algorithm to roots or LSPs of the polynomial representing the synthesis error over a series of iterations, and includes computing a gradient of the synthesis error in terms of gradient vectors of the synthesized speech samples by generating partial derivatives, using a recursive algorithm, for terms of a polynomial representing the synthesized speech samples over a series of iterations.

This application is a non-provisional application of U.S. Provisional Patent Application Serial No. 60/422,928, entitled “Efficient Implementation for Joint Optimization of Excitation and Model Parameters with a General Excitation Function,” filed Nov. 1, 2002 and U.S. Provisional Patent Application Serial No. 60/434,513, entitled “Joint Optimization of Model and Excitation in the Line Spectrum Frequency Domain,” filed Dec. 17, 2002.

### FIELD OF THE INVENTION

The present invention relates generally to speech coding, and more particularly, to an efficient encoder that employs a general excitation function.

### BACKGROUND

Speech compression is a well-known technology for encoding speech into digital data for transmission to a receiver, which then reproduces the speech. The digitally encoded speech data can also be stored in a variety of digital media between encoding and later decoding (i.e., reproduction) of the speech.

Speech communication over digital networks such as the Internet and ISDN requires efficient methods for converting the analog speech and audio signals into corresponding digital formats. These techniques and methodologies for effectively converting analog speech to digital speech are referred to as speech coding.

Speech coding systems differ from other analog and digital encoding systems that directly sample an acoustic sound at high bit rates and transmit raw sampled data to the receiver. Direct sampling systems usually produce a high quality reproduction of the original sound and are typically preferred when quality reproduction is especially important. Common examples where direct sampling systems are usually used include music phonographs, cassette tapes (analog), music compact discs and DVDs (digital). One disadvantage of direct digital sampling systems, however, is the large bandwidth and memory required for transmission and storage of the data respectively. Thus, for example, in a typical encoding system that transmits raw digital data sampled from an, original speech sound, a data rate as high as 128,000 bits per second is often required.

In contrast, speech coding systems use a mathematical model of the human speech production mechanism. The fundamental techniques of speech modeling are known in the art and are described in B. S. Atal and Suzanne L. Hanauer, Speech Analysis and Synthesis by Linear Prediction of the Speech Wave, The Journal of the Acoustical Society of America, pg. 637-55 (vol. 50 1971). The model of human speech production used in speech coding systems is usually referred to as the source-filter model. Generally, this model includes an excitation signal that represents air flow produced by the vocal folds, and a synthesis filter that represents the vocal tract (i.e., the glottis, mouth, tongue, nasal cavities and lips). Therefore, the excitation signal acts as an input signal to the synthesis filter similar to the way the vocal folds produce air flow to the vocal tract. The synthesis filter then alters the excitation signal to represent the way the vocal tract manipulates the air flow from the vocal folds. The resulting synthesized speech signal becomes an approximate representation of the original speech.

One advantage of speech coding systems is that the memory required to store or the bandwidth needed to transmit a digitized form of the original speech can be greatly reduced compared to direct sampling systems. Thus, by comparison, whereas direct sampling systems transmit raw acoustic data to describe the original sound, speech coding systems transmit only a limited amount of control data needed to recreate the mathematical speech model. As a result, a typical speech synthesis system can reduce the bandwidth needed to transmit speech to between about 2,400 to 8,000 bits per second. Similarly, the memory needed to store the coded speech is between 300 to 1000 bytes per second compared to 16 kilobytes per second for raw speech. This corresponds to a compression ratio (or saving) of 16:1 to 40:1.

One problem with speech coding systems, however, is that the quality of the reproduced speech is sometimes relatively poor compared to direct sampling systems. Most speech coding systems provide sufficient quality for the receiver to accurately perceive the content of the original speech. However, in some speech coding systems, the reproduced speech is not transparent. That is, while the receiver can understand the words originally spoken, the quality of the speech may be poor or annoying. Thus, a speech coding system that provides a more accurate speech production model is desirable.

One solution that has been recognized for improving the quality of the speech coding systems is described in U.S. patent application Ser. No. 09/800,071, entitled “Joint Optimization of Excitation and Model Parameters in Parametric Speech Coders,” filed Mar. 6, 2000 to Lashkari et al., hereby incorporated by reference. Briefly stated, this solution involves minimizing a synthesis error between an original speech sample and a synthesized speech sample. One difficulty that was discovered in certain speech coding systems, however, is the highly nonlinear nature of the synthesis error, which made the problem mathematically ill behaved. This difficulty was overcome by solving the problem using the roots of the synthesis filter polynomial instead of coefficients of the polynomial. Accordingly, a root optimization algorithm is described therein for finding the roots of the synthesis filter polynomial.

One improvement upon the above-mentioned solution is described in U.S. patent application Ser. No. 10/039,528, entitled “Complete Optimization of Model Parameters in Parametric Speed Coders,” filed Oct. 26, 2001, to Lashkari et al. This patent application describes an improved gradient descent algorithm that may be used with iterative root searching algorithms. Briefly stated, the improved gradient search algorithm recalculates the gradient vector at each iteration of the optimization algorithm to take into account the variations of the decomposition coefficients with respect to the roots. Thus, the improved gradient descent algorithm provides a better set of roots in comparison to algorithms that assume the decomposition coefficients are constant during successive iterations.

One remaining problem with the optimization algorithm, however, is the large amount of computational power that is required to encode the original speech. As those in the art well know, a central processing unit (“CPU”) or a digital signal processor (“DSP”) is often needed by speech coding systems to calculate the various mathematical formulas used to code the original speech. Oftentimes, when a mobile unit, such as a mobile phone, performs speech coding the CPU or DSP is powered by an on-board battery. Thus, the computational capacity available for encoding speech is usually limited by the speed of the CPU or DSP or the capacity of the battery. Although this problem is common in all speech coding systems, it is especially significant in systems that use optimization algorithms. Typically, optimization algorithms provide higher quality speech by including extra mathematical computations in addition to the standard encoding algorithms. However, inefficient optimization algorithms require more expensive, heavier and larger CPUs and DSPs, which have greater computational capacity. Inefficient optimization algorithms also use more battery power, which results in shortened battery life. Therefore, an efficient optimization algorithm is desired for speech coding systems.

An efficient optimization algorithm was described in U.S. patent application Ser. No. 10/023,826, entitled “Efficient Implementation of Excitation and Model Parameters in Multipulse Speech Coders,” filed Dec. 19, 2001, to Lashkari et al. for multipulse speech coders. The efficient encoder uses an improved optimization algorithm that takes into account the sparse nature of the multipulse excitation by performing the computations for the gradient vector only where the excitation pulses are non-zero. As a result, the improved algorithm significantly reduces the number of calculations required to optimize the synthesis filter for multipulse coders with sparse excitation. However, in state-of-the-art CELP-type speech coders such as the International Telecommunications Union (ITU) standard G.729, the excitation is sparse but not zero. The excitation function has nonzero values almost everywhere in the analysis frame. In this case, the efficient algorithm described in the aforementioned patent cannot be used. An efficient algorithm that can handle a general (non-sparse) excitation function is required for CELP-type speech coders.

### BRIEF SUMMARY

A method and apparatus for generating excitation and model parameters in source filter models are described. In one embodiment, the method comprises generating synthesized speech samples, using a synthesis filter, in response to an excitation signal, determining a synthesis error between the original speech samples and the synthesized speech sample and substantially reducing the synthesis error by computing both the excitation signal and filter parameters for the synthesis filter. Substantially reduction in the synthesis error is achieved by applying a gradient descent algorithm to the polynomial representing the synthesis error over a series of iterations, and includes computing a gradient of the synthesis error in terms of gradient vectors of the synthesized speech samples by generating partial derivatives, using a recursive algorithm, for terms of a polynomial representing the synthesized speech samples over a series of iterations.

### BRIEF DESCRIPTION OF SEVERAL VIEWS OF THE DRAWINGS

The invention, including its construction and method of operation, is illustrated more or less diagrammatically in the drawings, in which:

FIG. 1 is a block diagram of one embodiment of a speech analysis-by-synthesis system;

FIG. 2A is a flow diagram depicting operation of the speech analysis system using model optimization only;

FIG. 2B is a flow diagram of an alternative embodiment of a speech synthesis system using exhaustive joint optimization of the model parameters and the excitation signal;

FIG. 2C is a flow diagram of another alternative embodiment of a speech synthesis system using joint optimization of the model parameters and the excitation signal;

FIG. 3 is a flow diagram illustrating computational operations performed in one embodiment of an efficient optimization algorithm;

FIGS. 4A and 4B are timeline-amplitude charts, comparing an original speech sample to a G.729 synthesized speech and an optimally synthesized G.729 speech;

FIG. 5 is a spectral chart, comparing the spectra of the original speech sample to a G.729 synthesized speech and an optimally synthesized G.729 speech;

FIG. 6 is a block diagram of an excitation function and model optimization device.

FIG. 7A is a flow diagram of another embodiment of the speech synthesis system using model optimization only;

FIG. 7B is a flow diagram of an alternative embodiment of a speech synthesis system using joint optimization of the model parameters and the excitation signal by exhaustively searching for the best possible excitation;

FIG. 7C is a flow diagram of another alternative embodiment of a speech synthesis system using joint optimization of the model parameters and the excitation signal by updating the excitation signal at each iteration of the gradient descent algorithm;

FIG. 8 is a flow diagram of computational operations used in one embodiment of a LSF domain optimization algorithm;

FIG. 9 is a timeline-amplitude chart, comparing an original speech sample to a G.729 synthesized speech and an optimally synthesized G.729 speech; and

FIG. 10 is a spectral chart, comparing the spectra of the original speech sample to a G.729 synthesized speech and an optimally synthesized G.729 speech.

### DESCRIPTION

A speech coding system is provided for improving the mathematical model of a human speech production mechanism. The speech coding system includes an encoder that uses a recursive algorithm for computing the gradient vector that can be used with any excitation function. As a result, the improved algorithm significantly reduces the number of calculations required to improve a synthesis filter in coders such as, for example, CELP-type coders.

In one embodiment, the improvement in the mathematical model is done in terms of roots. To further increase the computational efficiency, roots are partitioned into complex and real roots. For complex roots, the calculations are performed only for one of the conjugate roots using complex arithmetic. The gradient for the other root is obtained by a simple conjugate operation. For real roots, the computations are performed using real arithmetic. This partitioning reduces the computations by another factor of two. The efficiency of the algorithm is improved by approximately 95% without changing the quality of the encoded speech.

In another embodiment, the improvement in the mathematical model is done in terms of line spectrum pairs (LSPs). The speech coding system includes a recursive algorithm for computing the gradient vector that can be used with any excitation function. As a result, the improved algorithm reduces the number of calculations that are required to find the roots and computations are performed using real arithmetic.

The efficient optimization algorithms described herein are provided for coders that employ a general excitation function such as, for example, the CELP-type speech coding systems. In one embodiment, the efficient implementation computes the partial derivatives using a recursive algorithm. Accordingly, improvements of 95% in computational load are possible with the efficient optimization algorithm without affecting the quality of the reproduced speech.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

An Exemplary Speech Coding System

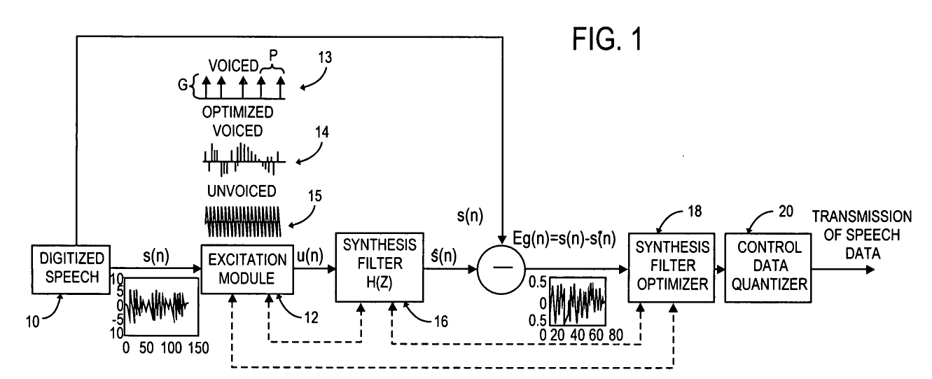

FIG. 1 is a block diagram of one embodiment of a speech coding system that reduces, and potentially minimizes, the synthesis error in order to more accurately model the original speech. In FIG. 1, an analysis-by-synthesis (“AbS”) system is shown which is commonly referred to as a source-filter model. As is well known in the art, source-filter models are designed to mathematically model human speech production. Typically, the model assumes that the human sound-producing mechanisms that produce speech remain fixed, or unchanged, during successive short time intervals, or frames (e.g., 10 to 30 ms analysis frames). The model further assumes that the human sound producing mechanisms can change between successive intervals. The physical mechanisms modeled by this system include air pressure variations generated by the vocal folds, glottis, mouth, tongue, nasal cavities and lips. Thus, the speech decoder reproduces the model and recreates the original speech using only a small set of control data for each interval. Therefore, unlike conventional sound transmission systems, the raw sampled data of the original speech is not transmitted from the encoder to the decoder. As a result, the digitally encoded data that is actually transmitted or stored (i.e., the bandwidth or the number of bits) is much less than those required by typical direct sampling systems.

Accordingly, referring to FIG. 1, original digitized speech 10 is delivered to an excitation module 12. The excitation module 12 then analyzes each sample s(n) of the original speech and generates an excitation function u(n). The excitation function u(n) is typically a series of pulses that represent air bursts from the lungs, which are released by the vocal folds to the vocal tract. Depending on the nature of the original speech sample s(n), the excitation function u(n) may be a voiced 13, optimized voice 14 or an unvoiced signal 15.

One way to improve the quality of reproduced speech in speech coding systems involves improving the accuracy of the voiced excitation function u(n). Traditionally, the excitation function u(n) has been treated as a series of pulses 13 with a fixed magnitude G and period P between the pitch pulses. As those in the art well know, the magnitude G and period P may vary between successive intervals. In contrast to the traditional fixed magnitude G and period P, it has previously been shown in the art that speech synthesis can be improved by optimizing the excitation function u(n) by varying the magnitude and spacing of the excitation pulses 14. This improvement is described in Bishnu S. Atal and Joel R. Remde, A New Model of LPC Excitation For Producing Natural-Sounding Speech At Low Bit Rates, IEEE International Conference on Acoustics, Speech, and Signal Processing 614-17 (1982). This optimization technique usually requires more intensive computing to encode the original speech s(n). However, in prior systems, this problem has not been a significant disadvantage since modern CPUs and DSP chips usually provide sufficient computing power for creating the excitation function u(n) of optimized voiced 14. A greater problem with this improvement has been the additional bandwidth required to transmit the information for the variable excitation pulses of optimized voiced 14. One solution to this problem is a coding system that is described in Manfred R. Schroeder and Bishnu S. Atal, Code-Excited Linear Prediction (CELP): High-Quality Speech at Very Low Bit Rates, IEEE International Conference on Acoustics, Speech, and Signal Processing, 937-40 (1985). This solution involves categorizing a number of optimized excitation functions into a library of functions, or a fixed codebook. In such a system, excitation module 12 generates the excitation function by adding two components: 1) a scaled version of the excitation from the previous speech frame, referred to as the adaptive codebook excitation and 2) an optimized excitation function from a fixed codebook, referred to as the innovative codebook excitation. The combined excitation produces a synthesized speech that most closely matches the original speech s(n). Next, a code or index that identifies the optimum codebook entry and the quantized scale factor is transmitted to the decoder. When the decoder receives the transmitted code, the decoder then accesses a corresponding codebook to reproduce the selected optimal excitation function u(n).

Excitation module 12 can also generate an unvoiced 15 excitation function u(n). An unvoiced 15 excitation function u(n) is used when turbulent air flow is produced through the vocal tract. Most types of excitation module 12 model this state by generating an excitation function u(n) consisting of unvoiced speech 15, or white noise (i.e., a random signal) instead of pulses.

In one example of a typical speech coding system, an analysis frame of 10 ms may be used in conjunction with a sampling frequency of 8 kHz. Thus, in this example, 80 speech samples are taken and analyzed for each 10 ms frame. In standard linear predictive coding (“LPC”) systems, excitation module 12 usually produces one to four pulses for each 10 ms analysis frame of voiced sound. By comparison, in code-excited linear prediction (“CELP”) systems, excitation module 12 usually produces one pulse for every speech sample, that is, eighty pulses per frame in the present example.

Next, synthesis filter 16 models the vocal tract and its effect on the air flow from the vocal folds. Typically, synthesis filter 16 uses a polynomial equation to represent the various shapes of the vocal tract. This technique can be visualized by imagining a multiple section hollow tube with several different diameters along the length of the tube. Accordingly, synthesis filter 16 alters the characteristics of the excitation function u(n) similar to the way the vocal tract alters the air flow from the vocal folds, or in other words, like the variable diameter hollow tube example alters inflowing air.

According to Atal and Remde, supra., synthesis filter 16 can be represented by the mathematical formula:

H(z)=G/A(z) (1)

where G is a gain term representing the loudness over a voice frame (about 10 ms). A(z) is a polynomial of order M and can be represented by the formula:

$$A ( z ) = 1 + {\sum }_{k = 1}^{M} {a}_{k} {z}^{- k} \qquad ( 2 )$$

The order of the polynomial A(z) can vary depending on the particular application, but a 10th order polynomial is commonly used with an 8 kHz sampling rate. From (2), the relationship of the synthesized speech ŝ(n) to the excitation function u(n) as determined by synthesis filter 16 can be defined by the formula:

$$\hat{s} ( n ) = Gu ( n ) - {\sum }_{k = 1}^{M} {a}_{k} \hat{s} ( n - k ) \qquad ( 3 )$$

Conventionally, the coefficients a₁ . . . a_{M} of this polynomial are computed using a technique known in the art as linear predictive coding (“LPC”). LPC-based techniques compute the polynomial coefficients a₁ . . . a_{M} by minimizing the total prediction error Eₚ. Accordingly, the predicted speech sample \tilde{s}(n) and the sample prediction error eₚ(n) are defined by the formulas:

$$\begin{matrix}\tilde{s} ( n ) = - {\sum }_{k = 1}^{M} {a}_{k} s ( n - k ) & ( 4 a ) \\ {e}_{p} ( n ) = s ( n ) - \tilde{s} ( n ) = s ( n ) + {\sum }_{k = 1}^{M} {a}_{k} s ( n - k ) & ( 4 b )\end{matrix}$$

The total prediction error Eₚ is then defined by the formula:

$${E}_{p} = {\sum }_{k = 0}^{N - 1} {e}_{p}^{2} ( k ) \qquad ( 5 )$$

where N is the length of the analysis frame expressed in number of samples. The polynomial coefficients a₁ . . . a_{M} can now be computed by minimizing the total prediction error Eₚ using well known mathematical techniques.

One problem with the LPC technique of computing the polynomial coefficients a₁ . . . a_{M} is that only the total prediction error is minimized. Thus, the LPC technique does not minimize the error between the original speech s(n) and the synthesized speech ŝ(n). Accordingly, the sample synthesis error eₛ(n) can be defined by the formula:

eₛ(n)=s(n)−ŝ(n) (6)

There are two differences between the prediction error in (4) and the synthesis error in (6). First prediction error uses past samples of the original speech whereas synthesis error uses past samples of the synthesized speech. Second, the prediction scheme (equation (4a)) assumes the excitation function is either zero or white noise, whereas synthesis error takes into account the contribution of a general excitation function. The total synthesis error Eₛ can then be defined by the formula:

$${E}_{s} = {\sum }_{n = 0}^{N - 1} {e}_{s}^{2} ( n ) = {\sum }_{n = 0}^{N - 1} {( s ( n ) - \hat{s} ( n ) )}^{2} \qquad ( 7 )$$

where as before, N is the length of the analysis frame in number of samples. Like the total prediction error Eₚ discussed above, the total synthesis error Es should be minimized to compute the optimum filter coefficients a₁ . . . a_{M}. However, one difficulty with this technique is that the synthesized speech ŝ(n), as represented in formula (3), makes the total synthesis error Eₛ a highly nonlinear function of the filter coefficients that is not generally well behaved mathematically.

One solution to this mathematical difficulty is to minimize the total synthesis error Eₛ using the roots of the polynomial A(z) instead of the coefficients a₁ . . . a_{M}. Using roots instead of coefficients for optimization also provides control over the stability of synthesis filter 16. Accordingly, assuming that h(n) is the impulse response of the synthesis filter 16, the synthesized speech ŝ(n) is now defined by the formula:

$$\hat{s} ( n ) = h ( n ) * u ( n ) = {\sum }_{k = 0}^{n} h ( k ) u ( n - k ) n = 0 , 1 , 2 … N - 1 \qquad ( 8 )$$

where * is the convolution operator. In this formula, it is also assumed that the excitation function u(n) is zero outside of the interval 0 to N−1.

Using the roots of A(z), the polynomial can now be expressed by the formula:

A(z)=(1−λ₁z⁻¹) . . . (1−λ_{M}z⁻¹) (9)

where λ₁ . . . λ_{M} represent the roots of the polynomial A(z). These roots may be either real or complex. Thus, in a 10th order polynomial, A(z) has 10 distinct roots.

Using parallel decomposition, the synthesis filter transfer function H(z) is now represented in terms of the roots by the formula:

$$H ( z ) = 1 / A ( z ) = {\sum }_{i = 1}^{M} {b}_{i} / ( 1 - {λ}_{i} {z}^{- 1} ) \qquad ( 10 )$$

(the gain term G is omitted from this and the remaining formulas for simplicity). The decomposition coefficients bᵢ are then calculated by the residue method for polynomials, thus providing the formula:

$${b}_{i} = {\prod }_{j = i , j \neq i}^{M} ( 1 / ( 1 - {λ}_{j} {λ}_{i}^{- 1} ) ) \qquad ( 11 )$$

The impulse response h(n) can also be represented in terms of the roots by the formula:

$$h ( n ) = {\sum }_{i = 1}^{M} {{b}_{i} ( {λ}_{i} )}^{n} \qquad ( 12 )$$

Next, by combining formula (12) with formula (8), the synthesized speech s(n) can be expressed by the formula:

$$\hat{s} ( n ) = {\sum }_{k = 0}^{n} h ( k ) u ( n - k ) = {\sum }_{k = 0}^{n} u ( n - k ) {\sum }_{i = 1}^{M} {{b}_{i} ( {λ}_{i} )}^{k} \qquad ( 13 )$$

The total synthesis error Eₛ can be minimized using polynomial roots and a gradient descent algorithm by substituting formula (13) into formula (7). A number of optimization algorithms may be used to minimize the total synthesis error Eₛ. However, one possible algorithm is an iterative gradient descent algorithm. Accordingly, denoting the root vector at the j-th iteration as Λ^{(j)}, the root vector can be expressed by the formula:

Λ^{(j)}=[λ₁^{(j)} . . . λᵣ^{(j)} . . . λ_{M}^{(j)}]^{T} (14)

Where λᵣ^{(j)} is the value of the r-th root at the j-th iteration and T is the transpose operator. The search begins with the LPC solution as the starting point, which is expressed by the formula:

Λ⁽⁰⁾=[λ₁⁽⁰⁾ . . . λᵣ⁽⁰⁾ . . . λ_{M}⁽⁰⁾]^{T} (15)

To compute Λ⁽⁰⁾, the LPC coefficients a₁ . . . a_{M} are converted to the corresponding roots λ₁⁽⁰⁾ . . . λ_{M}⁽⁰⁾ using a standard root finding algorithm such as the Newton Raphson method. Next, the roots at subsequent iterations can be computed using the formula:

Λ^{(j+1)}=Λ^{(j)}+μⱼ∇ⱼEₛ (16)

where μⱼ is the step size and ∇ⱼEₛ is the gradient of the synthesis error Eₛ relative to the roots at iteration j. The step size μ can be either fixed for each iteration, or alternatively, it can be variable and adjusted for each iteration. Using formula (7), the synthesis error gradient vector ∇ⱼEₛ can now be calculated by the formula:

$${∇}_{j} {E}_{s} = {\sum }_{k - 1}^{N - 1} {e}_{s} ( k ) {∇}_{j} \hat{s} ( k ) \qquad ( 17 )$$

Formula (17) demonstrates that the synthesis error gradient vector ∇ⱼEₛ can be calculated using the gradient vectors of the synthesized speech samples ŝ(k). Accordingly, the synthesized speech gradient vector ∇ⱼŝ(k) can be defined by the formula:

∇ⱼŝ(k)=└∂ŝ(k)/∂λ₁^{(j)} . . . ∂ŝ(k)/∂λᵣ^{(j)} . . . ∂ŝ(k)/∂λ_{M}^{(j)}┘ (18)

where ∂ŝ(k)/∂λᵣ^{(j)} is the partial derivative of ŝ(k) at iteration j with respect to the r-th root. Using formula (13), the partial derivatives ∂ŝ(k)/∂λᵣ^{(j)} can be computed by the formula:

$$\frac{\partial \hat{s} ( k )}{\partial {λ}_{r}^{( j )}} = {b}_{r} {\sum }_{m = 1}^{k} mu ( k - m ) {( {λ}_{r}^{( j )} )}^{m - 1} k = 1 , 2 , … ( N - 1 ) \qquad ( 19 )$$

where ∂ŝ(0)/∂λᵣ^{(j)} is always zero so that we do not consider the case k=0.

The synthesis error gradient vector ∇ⱼEₛ is now calculated by substituting formula (19) into formula (18) and formula (18) into formula (17). The updated root vector Λ^{(j+1)} at the next iteration can then be calculated by substituting the result of formula (17) into formula (16). After the root vector Λ^{(j)} is recalculated, the decomposition coefficients bᵢ are updated prior to the next iteration using formula (11). A detailed description of one algorithm for updating the decomposition coefficients is described in U.S. patent application Ser. No. 10/039,528, entitled “Complete Optimization of Model Parameters in Parametric Speed Coders,” filed Oct. 26, 2001, to Lashkari et al. In alternative embodiments, the iterations of the gradient descent algorithm are repeated until either the step-size becomes smaller than a predefined value μₘᵢₙ, a predetermined number of iterations are completed, or the roots are resolved within a predetermined distance from the unit circle. Note that the optimization operation described above is performed by synthesis filter optimizer 18 of FIG. 1.

It is common in the art to define one floating-point operation (or flop) as one real addition plus one real multiplication. Using this definition, the number of computations per iteration per frame necessary to implement the optimization algorithm is a follows:

1) Starting from equation (3), the number of operations Nₛ needed to compute the synthesized speech ŝ(n) are:

Nₛ=4MN flops (20a)

2) the number of operations N_{b} needed to compute the decomposition coefficients bᵢ are:

N_{b}=4M² flops (20b)

3) Number of operations Nᵤ necessary to update the root vector in equation (16) is:

Nᵤ=M flops (20c)

4) Number of operations N_{g} needed to compute the M components of the gradient vector from equation (17) is:

N_{g}=2M(N−1) flops (20d)

5) Total number of operations Nₚ for computing the root powers and partial derivatives for the entire frame from equation (19) is:

Nₚ=M(N−1)(3N/2+2) flops (20e)

The total number of operations N_{T} is simply the sum of the above figures.

N_{T}=Nₛ+N_{b}+Nᵤ+N_{g}+Nₚ (20f)

The initial LPC roots λ₁⁽⁰⁾ . . . λ_{M}⁽⁰⁾ in equation (15) are calculated by using established root finding techniques such as the Newton-Raphson or interval halving methods. Initial roots are computed once per frame only.

For typical values of M=10 and N=80 for the ITU-T standard G.729, we get Nₛ=800 flops, N_{b}=400 flops, Nᵤ=10 flops, N_{g}=1580 flops, Nₚ=96380 flops and N_{T}=99170. As demonstrated by this example, by far the bulk of the operations (97% in this example) are in computing the partial derivatives in equation (19).

In LPC and multipulse coders, the excitation function u(n) is relatively sparse. That is, non-zero pulses occur at only a few samples in the entire analysis frame, with most samples in the analysis frame having no pulses. For LPC encoders, as few as one pulse per frame may exist, while multipulse coders may have as few as 10 pulses per frame. For these codecs the method described in U.S. patent application Ser. No. 10/023,826, entitled “Efficient Implementation of Joint Optimization of Excitation and Model Parameters in Multipulse Speech Coders,” filed Dec. 19, 2001, to Lashkari et al. significantly reduces the computational load.

For CELP-type coders however, we can have as many as one pulse per sample or 80 pulses per 10 ms for the ITU standard G.729 and need a method that can reduce the computations for a general excitation function. The recursive algorithm described herein is an efficient method for computing the partial derivatives and is applicable to general excitation functions such as those employed by the CELP-type coders.

Let ŝᵢ(n) represent the synthesized speech due to the i-th root λᵢ only. Then ŝᵢ(n) can be written as:

$${\hat{s}}_{i} ( n ) = {b}_{i} {\sum }_{k = 0}^{n} u ( n - k ) {( {λ}_{i} )}^{k} i = 1 , 2 , … M \qquad ( 21 )$$

which is a special case of equation (13) when we have one root only. The partial derivatives ∂ŝ(k)/∂λᵣ^{(j)} in equation (19) and ŝᵢ(k) in equation (13) can be recursively computed as:

ŝᵢ(k+1)=λᵢŝᵢ(k)+u(k) (22a)

∂ŝ(k+1)/∂λᵢ=λᵢ∂ŝ(k)/∂λᵢ+ŝᵢ(k) (22b)

The initial conditions for these recursions are:

ŝᵢ(0)=0 i=1, 2, . . . M (22c)

∂ŝ(0)/∂λᵢ=0 i=1, 2, . . . M (22d)

The number of computations per frame N_{E} using equations (22a) and (22b) is:

N_{E}=4M(N−1) (23)

Furthermore, as a byproduct of this recursion, the synthesized speech ŝ(n) in equation (13) can be computed by adding the M synthesized speech components ŝᵢ(n) for all the roots. This requires NM real additions.

One advantage of the improved optimization algorithm can now be appreciated. The computation of the partial derivatives ∂ŝ(k+i)/∂λᵢ using the recursions in (22a) and (22b) requires far fewer operations than previously required. Thus, whereas about 96380 operations per iteration per frame (or 96380/80=1205 operations per sample) were previously required, only 3160 operations per iteration per frame or about 39 operations per sample are now required for the G.729 CELP coder, corresponding to a 97% reduction in the number of operations for computing the gradient vector. The total number of operations per iteration per frame is reduced from 99170 flops to 5150 flops, a 95% reduction in the computational load for CELP-type speech coders. This means that the new algorithm runs about 20 times faster on the same CPU.

Although control data for the optimal synthesis polynomial A(z) can be transmitted in a number of different formats, for compatibility with the existing standards, it is preferable to convert the roots found by the optimization technique described above back into polynomial coefficients a₁ . . . a_{M}. The conversion can be performed by well known mathematical techniques. This conversion allows the optimized synthesis polynomial A(z) to be transmitted in the same format as existing speech coding systems, thus promoting compatibility with current standards.

Now that the synthesis model has been completely determined, the control data for the model is quantized into digital bit stream for transmission or storage by control data quantizer 20. Many different industry standards exist for quantization. Commonly, in the ITU-T G.729 speech coder the control data are quantized into a total of 80 bits. This corresponds to one bit per sample after compression. Thus, according to this example, the synthesized speech ŝ(n), including optimization, can be transmitted with a data rate of 8,000 bits/s (80 bits/frame÷0.010 s/frame).

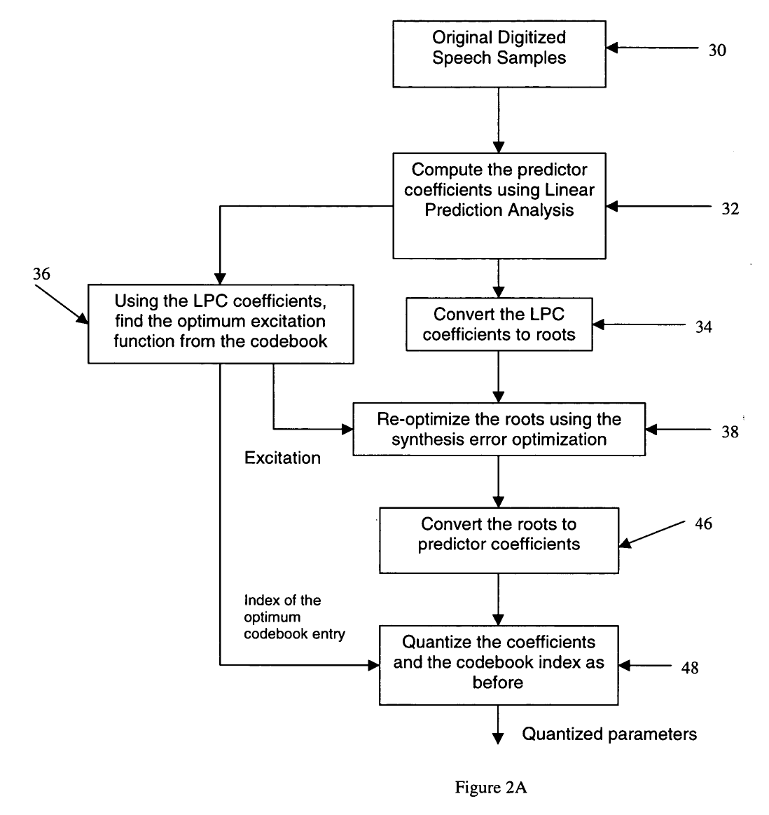

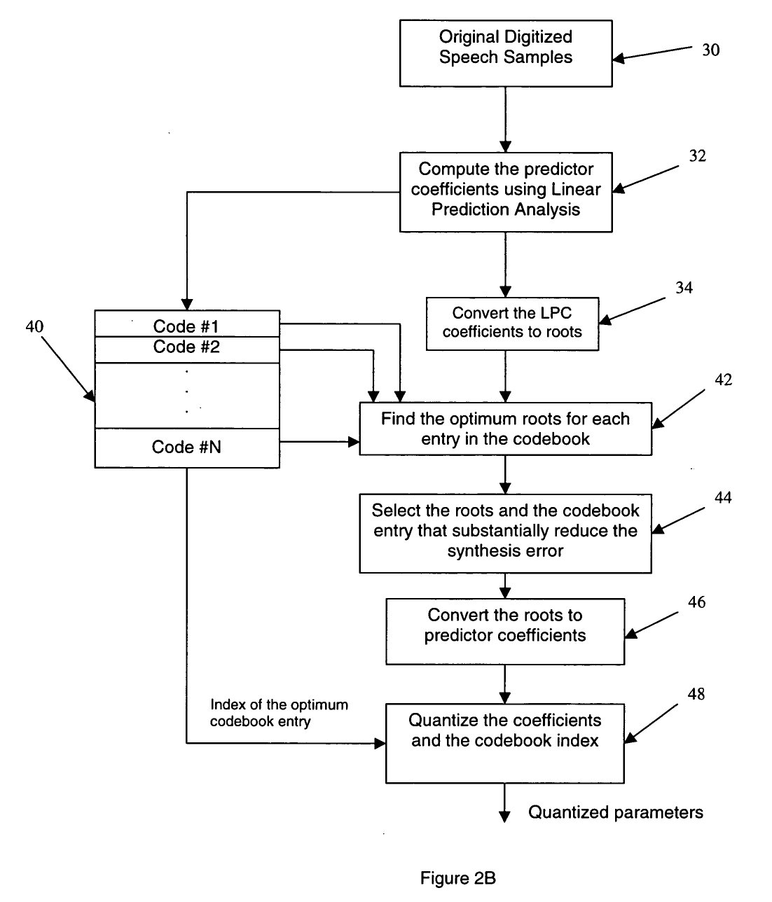

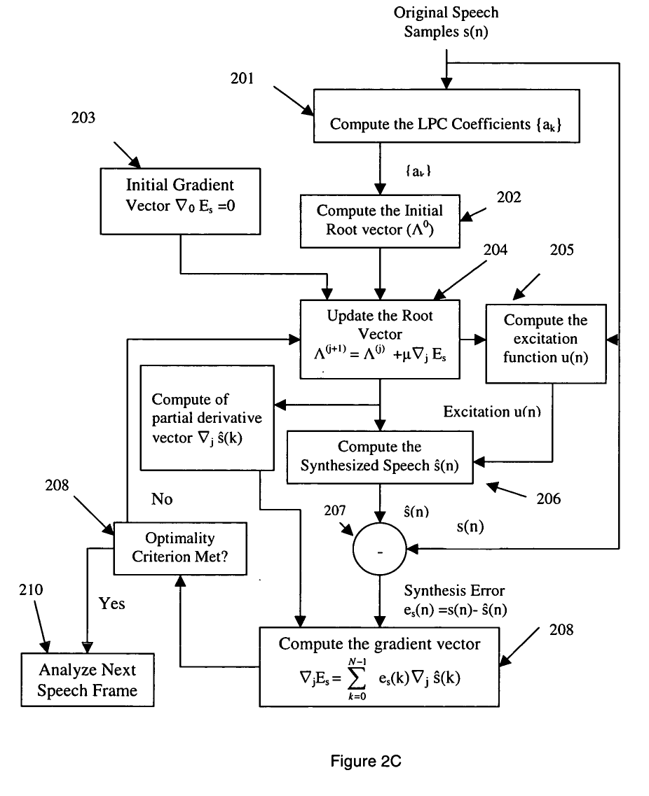

As shown in both FIGS. 1 and 2A-2C, the order of operations can be changed depending on the accuracy desired and the computing resources available. Thus, in the embodiment described above, the excitation function u(n) was first determined to be a preset series of pulses 13 for voiced speech or random noise for unvoiced speech 15. Second, the initial synthesis filter polynomial A(z) was determined using conventional techniques, such as the LPC method. Third, the synthesis filter polynomial A(z) was optimized.

FIG. 2A shows a block diagram of the model optimization only. In this case, the initial excitation function found using the LPC technique is used to substantially optimize only the synthesis filter polynomial A(z). That is, throughout the optimization process the excitation signal u(n) does not change. In FIGS. 2B and 2C, a different encoding sequence is shown that is applicable to joint optimization of multipulse and CELP-type speech coders which should provide even more accurate synthesis. Here, the both the excitation signal u(n) and the synthesis filter polynomial A(z) change as a result of the optimization process. However, some additional computing power will be needed. The processing described in FIGS. 2A, 2B and 2C are performed by processing logic that may comprise hardware (e.g., circuitry, dedicated logic, etc.), software (such as is run on a general purpose computer system or a dedicated machine), or a combination of both.

Referring to FIGS. 2A, 2B and 2C, processing logic begins with original digitized speech sample (processing block 30) and computes the polynomial coefficients a₁ . . . a_{M} using the LPC technique described above or another comparable method such as the Levinson-Durbin recursions (processing block 32). Next, processing logic finds the optimum excitation function u(n) from a codebook using the polynomial coefficients a₁ . . . a_{M} (processing block 36).

After selection of the excitation function u(n), processing logic optimizes the polynomial coefficients a₁ . . . a_{M}. To make optimization of the coefficients a₁ . . . a_{M} easier, processing logic converts the polynomial coefficients a₁ . . . a_{M} to the roots of the polynomial A(z) (processing block 34) and uses a gradient descent algorithm to optimize the roots using the synthesis error optimization (processing block 38). Once the optimal roots are found, processing logic converts the roots back to polynomial coefficients a₁ . . . a_{M} for compatibility with the existing encoding-decoding systems (processing block 46). Lastly, processing logic quantizes the coefficients and the index to the codebook entry for transmission or storage (processing block 48).

Referring to FIG. 2B, processing logic begins with original digitized speech sample (processing block 30) and computes the polynomial coefficients a₁ . . . a_{M} using the LPC technique described above or another comparable method (processing block 32). Then processing logic finds an individual excitation function u(n) from the codebook for each frame (processing block 40).

After selection of the excitation function u(n), processing logic optimizes the polynomial coefficients a₁ . . . a_{M}. To make optimization of the coefficients a₁ . . . a_{M} faster and to guarantee filter stability, processing logic converts the polynomial coefficients a₁ . . . a_{M} to the roots of the polynomial A(z) (processing block 34) and uses a gradient descent algorithm to find the optimum roots for each entry in the codebook (processing block 42) and selects the roots and the codebook entry that produces the minimum synthesis error (processing block 44). Once the optimal roots are found, processing logic converts the roots back to polynomial coefficients a₁ . . . a_{M} (predictor coefficients) for compatibility with the existing encoding-decoding systems (processing block 46). Lastly, processing logic quantizes the coefficients and the codebook index to the codebook entry for transmission or storage (processing block 48).

Additional encoding sequences are also possible for improving the accuracy of the synthesis model depending on the computing capacity available for encoding. Some of these alternative sequences are demonstrated in FIG. 1 by dashed routing lines. For example, the excitation function u(n) can be recomputed at various stages during optimization of the synthesis filter A(z).

While the optimization method shown in FIG. 2A only optimizes the parameters of the synthesis filter an additional optimization method is shown in FIG. 2C wherein both the model parameters and the excitation function are optimized at each iteration of the gradient descent algorithm. In FIG. 2A, the excitation signal u(n) is determined only once using the LPC coefficients and may be computed by using multi-pulse LPC, CELP or some other scheme. However, only the parameters of the synthesis filter are optimized to achieve the minimum synthesis error. Therefore, each iteration of the gradient descent algorithm of the optimization method uses the same excitation function, wherein the excitation function was computed before the optimization method was implemented.

In contrast, an optimization method shown in FIG. 2C optimizes both the excitation function and the parameters of the synthesis filter model. Because both the model parameters and the excitation function are optimized, this additional optimization method is expected to produce greater optimization than the optimization method shown in FIG. 2A. FIG. 2C illustrates one embodiment of a process for jointly optimizing the model and the excitation. The optimization is performed by processing logic that may comprise hardware (e.g., circuitry, dedicated logic, etc.), software (such as is run on a general purpose computer system or a dedicated machine), or a combination of both.

Referring to FIG. 2C, the operation begins by processing logic using the original speech samples s(n) to compute the LPC coefficients (processing block 201). After computing the LPC coefficients, processing logic computes the initial root vector (processing block 202). Using the initial gradient vector (processing block 203) and the initial root vector, processing logic updates the root vector (processing block 204). Once the root vector has been updated, processing logic computes the excitation function u(n) using the original speech samples s(n) (processing block 205). That is the excitation function is recomputed after the roots have been updated at each iteration of the gradient descent algorithm. Thereafter, using the updated root vector and the newly computed excitation function, processing logic computes the synthesized speech (processing block 206). Using the synthesized speech, processing logic computes the synthesis error (processing block 207). With the synthesis error, processing logic computes the gradient vector (processing block 208).

Processing logic then tests whether optimality criteria have been met (processing block 209). If optimality criteria have not been met, processing transitions to processing block 204. If optimality criteria have been met, then processing transitions to analyze the next speech frame (processing block 210).

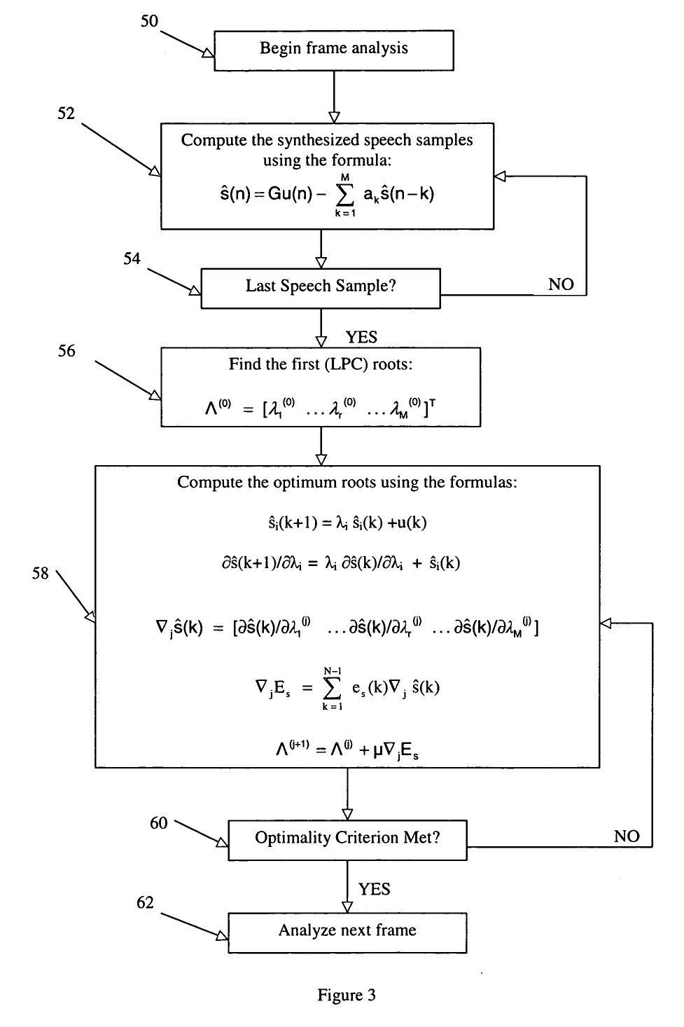

FIG. 3 shows one embodiment of a sequence of operations that requires fewer calculations to optimize the synthesis polynominal A(z). The sequence depicts the operations for one frame, and these operations are repeated for each frame of speech. The process in FIG. 3 is performed by processing logic that may comprise hardware (e.g., circuitry, dedicated logic, etc.), software (such as is run on a general purpose computer system or a dedicated machine), or a combination of both.

Referring to FIG. 3, processing logic begins frame analysis by computing the synthesized speech ŝ(n) for each sample in the frame using formula (3) above (processing block 52). Processing logic checks whether the current sample being processed is the last sample (processing block 54). If not, processing transitions to processing block 52. Note that the computation of the synthesized speech is repeated until the last sample in the frame has been computed. If it is, then processing transitions to processing block 56.

At processing block 56, processing logic computes the roots of the synthesis filter polynomial A(z) using a standard root finding algorithm. Next, processing logic optimizes the roots of the synthesis polynominal with an iterative gradient descent algorithm using formulas (19), (18), (17) and (16) described above (processing block 56).

Processing logic tests whether the optimality criteria are met (processing block 60) as iterations are repeated until some completion criteria are met, for example if an iteration limit has been reached. If not, then processing transitions back to processing block 56. If so, then processing proceeds to analyze the next frame, if any (processing block 62).

It is now apparent to those skilled in the art that the efficient optimization algorithm significantly reduces the number of calculations required to optimize the synthesis filter polynomial A(z). Thus, the efficiency of the encoder is greatly improved. Using previous optimization algorithms, the computation of the partial derivatives ∂ŝ(k)/∂λᵢ for each sample was a computationally intensive task. However, the improved optimization algorithm reduces the computational load required to compute the partial derivatives ∂ŝ(k)/∂λ₁ by using a recursive technique, thereby drastically reducing the number of calculations performed.

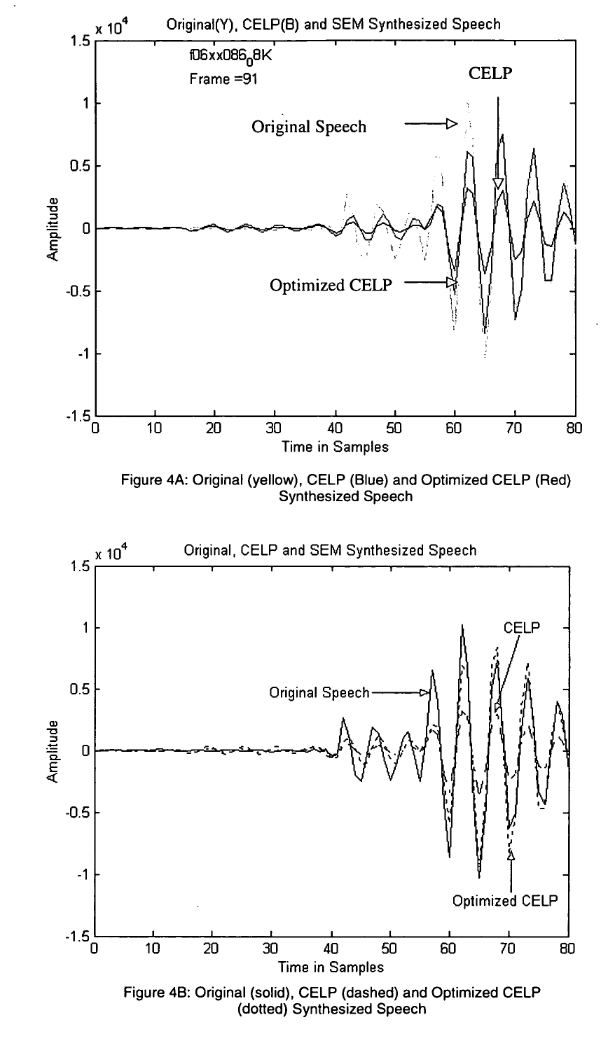

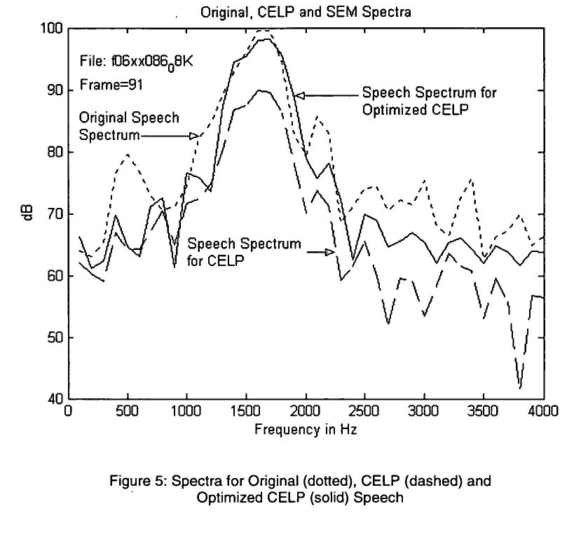

FIGS. 4A, 4B and 5 show the results provided by the more efficient optimization algorithm. These figures show several different comparisons between a prior art CELP synthesis system and the optimized synthesis system. The speech sample used for this comparison is a segment of a voiced part of letter “C.” As shown in the figures, another advantage of the improved optimization algorithm is that the quality of the speech synthesis optimization is unaffected by the reduced number of calculations. Accordingly, the optimized synthesis polynominal that is computed using the more efficient optimization algorithm is exactly the same as the optimized synthesis polynominal that would result without reducing the number of calculations. Thus, less expensive CPUs and DSPs may be used and battery life may be extended without sacrificing speech quality.

In FIGS. 4A and 4B, a timeline-amplitude chart of the original speech, a prior art CELP synthesized speech and the optimized synthesized speech is shown. As is shown, the optimally synthesized speech matches the original speech much closer than the non-optimal (LPC) synthesized speech.

FIG. 5 shows a spectral chart of the original speech, the CELP synthesized speech and the optimally synthesized speech. The first spectral peak of the original speech can be seen in this chart at a frequency of about 280 Hz. Accordingly, the spectrum of optimized synthesized speech waveform matches the 16000 Hz component of the original speech much better than the spectrum of the LPC synthesized speech waveform.

Joint Optimization of Model and Excitation in the Line Spectrum Frequency (LSF) Domain

Although roots can be computed using well-established numerical algorithms such as the Newton-Raphson and interval halving techniques, it is very desirable to avoid the root finding operation if possible. In an alternative embodiment, the optimization of the model and excitation occurs in the LSF domain.

Minimization in the LSP Domain

Let Γ⁽ⁱ⁾ denote the LSP vector at the i-th iteration of the gradient descent algorithm:

Γ⁽ⁱ⁾=[γ₁⁽ⁱ⁾ . . . γₖ⁽ⁱ⁾ . . . γ_{M}⁽ⁱ⁾]^{T} (24a)

Here γₖ⁽ⁱ⁾ is the value of the k-th LSP at the i-th iteration of the gradient descent algorithm and T stands for transpose. The algorithm starts from:

Γ⁽⁰⁾=└γᵢ⁽⁰⁾ . . . γₖ⁽⁰⁾ . . . γ_{M}⁽⁰⁾┘ (24b)

where Γ⁽⁰⁾ is the LSP vector corresponding to the LPC solution. To compute Γ⁽⁰⁾, the LPC coefficients {a₁ . . . a_{M}} are converted to the LSPs {γ₁⁽⁰⁾, . . . γ_{M}⁽⁰⁾} using a known conversion algorithm such as that described by F. Itakura, Line Spectrum Representation of Linear Predictive Coefficients of Speech Signals,” Journal of the Acoustical Society of America, Vol. 57, p. 535(A). Using the gradient descent algorithm, the LSPs at iteration (i+1) are given as:

$${Γ}^{( i + 1 )} = {Γ}^{( i )} + {μ}_{i} \frac{{∇}_{i} {E}_{s}}{\vert {∇}_{i} {E}_{s} \vert} \qquad ( 25 a )$$

where μᵢ is the step-size and ∇ᵢEₛ the gradient vector of the synthesis error relative to the LSPs (Γ⁽ⁱ⁾) at iteration i. As seen from (25a), the gradient vector is normalized by its magnitude. This normalization ensures that the difference between the parameter vectors at successive iterations is bounded by μᵢ, that is:

|Γ⁽ⁱ⁺¹⁾−Γ⁽ⁱ⁾|=μᵢ (25b)

From (7), the gradient vector can be computed as:

$${∇}_{i} {E}_{s} = {\sum }_{k = 1}^{N - 1} {e}_{s} ( k ) {∇}_{i} \hat{s} ( k ) \qquad ( 26 a )$$

Here, ∇ᵢŝ(k) is gradient vector of the synthesized speech sample ŝ(k).

∇ᵢŝ(k)=└∂ŝ(k)/∂γ₁⁽ⁱ⁾ . . . ∂ŝ(k)/∂γ_{M}⁽ⁱ⁾┘ (26b)

The terms ∂ŝ(k)/∂γᵣ⁽ⁱ⁾ are the partial derivatives at iteration i of ŝ(k) with respect to the r-th LSP. From (3), these terms can be computed recursively as follows.

$$\frac{\partial \hat{s} ( k )}{\partial {γ}_{r}^{( i )}} = \frac{- \partial [ {\sum }_{j = 1}^{M} {a}_{j} \hat{s} ( k - j ) ]}{\partial {γ}_{r}^{( i )}} \qquad ( 27 a )$$

Carrying the partial derivative inside the sum, the following equation is obtained:

$$\frac{\partial \hat{s} ( k )}{\partial {γ}_{r}^{( i )}} = - {\sum }_{j = 1}^{M} [ \hat{s} ( k - j ) ] \partial {a}_{j} / \partial {γ}_{r}^{( i )} + {a}_{j} \hat{s} ( k - j ) / \partial {γ}_{r}^{( i )} \qquad ( 27 b )$$

The following equality may be defined:

p(x,r)=∂ŝ(k)/∂γᵣ (28a)

and partial derivative of the coefficients aⱼ relative to the r^{th} parameter γᵣ, as:

d(j,r)=∂aⱼ/∂γᵣ (28b)

Now (27b) can be written as (we have dropped the superscript (i) for notational simplicity):

$$p ( k , r ) = - {\sum }_{j = 1}^{M} [ \hat{s} ( k - j ) d ( j , r ) + {a}_{j} p ( k - j , r ) ] \qquad ( 29 a )$$

with the initial conditions as:

p(k,r)=0 for k<0 (29b)

Hence, the partial derivatives can be recursively calculated once the quantities d(j,r) are known. The values of p(k,r) for k=0, 1, . . . M−1 depend on the initial conditions ŝ(−M), . . . ŝ(−1). Thus the effects of initial conditions are taken into account.

The partial derivatives from (29a) can be substituted into (26b) to compute the vector of partial derivatives, ∇ᵢŝ(k), (26b) can then be substituted into (26a) to compute the gradient vector ∇ᵢEₛ. Finally, (26a) can be substituted in (25a) to update the parameter vector Γ. The algorithm starts from the parameter vector Γ⁽⁰⁾ corresponding to the LPC solution and continues this process until some termination or optimality criterion has been satisfied such as when the step-size μᵢ is smaller than a predetermined value ε or after a predetermined number of iterations is reached. In general, the step-size μᵢ is not constant; it is adaptively adjusted at each iteration. Initially (at iteration zero) the process starts with a large step-size. If at any iteration, the synthesis filter becomes unstable or the synthesis error becomes larger than its value in the previous iteration, we go back to the parameter vector at the previous iteration and reduce the step-size by a known factor (of two for example). This process of adjusting the step-size continues until the error becomes lower than the value at the previous iteration.

Partial Derivatives of Filter Coefficients {aᵢ} Relative to the LSPs

LSPs are the roots of the two polynomials P(z) and Q(z) defined below. For even model order M, polynomials P(z) and Q(z) can be written as:

$$\begin{matrix}P ( z ) = 1 + {\sum }_{k = 1}^{M} {p}_{k} {z}^{- k} = {\prod }_{k = 1}^{k - M / 2} ( 1 - 2 cos {ω}_{2 k - 1} {z}^{- 1} + {z}^{- 2} ) & ( 30 a ) \\ Q ( z ) = 1 + {\sum }_{k = 1}^{M} {q}_{k} {z}^{- k} = {\prod }_{k = 1}^{k - M / 2} ( 1 - 2 cos {ω}_{2 k} {z}^{- 1} + {z}^{- 2} ) & ( 30 b )\end{matrix}$$

where ωₖ, k=1, 2, . . . M are the Line Spectrum Frequencies (LSFs) and γₖ=cos(ωₖ), k=1, 2, . . . M are the Line Spectrum Pairs (LSPs). Roots of P(z) give the odd LSPs and roots of Q(z) the even LSPs, and {pₖ} and {qₖ} are the coefficients of P(z) and Q(z) respectively.

Most parametric speech codecs use the LSPs as the transmission parameters because they have very desirable quantization properties. For even M, the coefficients {pᵢ}and {qᵢ} can be expressed in terms of the filter coefficients {aₖ}:

p_{M}=p₀=1 (31a)

p_{M-i}=pᵢ=−pᵢ₋₁+(aᵢ+a_{M+1-i}) i=1, 2. . . M/2 (31b)

q_{M}=q₀=1 (32a)

q_{M-i}=qᵢ=qᵢ₋₁+(aᵢ+a_{M+1-i}) i=1, 2 . . . M/2 (32b)

Similarly, the coefficients {a₁}in terms of the coefficients {pᵢ} and {qᵢ} can be expressed as follows:

aᵢ=(pᵢ+pᵢ₋₁+qᵢ−qᵢ₋₁)/2 i=1, 2 . . . M (33)

For example, for M=10 which is the typical model order used with the 8-kHz sampling frequency, the following equations are obtained:

a₁=(p₁+q₁)/2 (34a)

a₂=(p₁+p₂+q₁−q₂)/2 (34b)

a₃=(p₂+p₃+q₃−q₂)/2 (34c)

a₄=(p₃+p₄+q₄−q₃)/2 (34d)

a₅=(p₁+p₄+p₅+q₅−q₄−q₁)/2 (34e)

a₆=1+(p₁+p₄+p₅+q₄−q₁−q₅)/2 (34f)

a₇=(p₃+p₄+q₃−q₄)/2 (34g)

a₈=(p₂+p₃+q₂−q₃)/2 (34h)

a₉=(p₁+p₂+q₁−q₂)/2 (34i)

a₁₀=(p₁−q₁)/2 (34j)

Using the above relationship, the partial derivatives of the coefficients {aₖ} can be expressed relative to the LSPs in terms of the partial derivative of the coefficients {pᵢ} and {qᵢ} with respect to the LSPs. For example, using (33), the following can be written:

d(j,r)=∂aⱼ/∂γᵣ=0.5(∂pᵢ/∂γᵣ+∂qᵢ/∂γᵣ+∂pᵢ₋₁/∂γᵣ−∂qᵢ₋₁/∂γᵣ) (35a)

Since odd LSPs are the roots of P(z), therefore ∂pᵢ/∂γᵣ exists only for odd values of r. For r even, ∂pᵢ/∂γᵣ=0. Similarly since even LSPs are the roots of Q(z), therefore ∂qᵢ/∂γᵣ exists only for even values of r. For odd values of r, ∂qᵢ/∂γᵣ=0. Hence, equation (35a) can be written as:

d(j,r)=∂aⱼ/∂γᵣ=0.5(∂pⱼ/∂γᵣ+∂pⱼ₋₁/∂γᵣ) (35b)

d(j,r)=∂aⱼ/∂γᵣ=0.5(∂qⱼ/∂γᵣ−∂qᵢ₋₁/∂γᵣ) (35c)

Since {γᵢ}, . . . i=1, 2, . . . M are the roots of the polynomials P(z) and Q(z), the partial derivatives ∂pᵢ/∂γᵣ and ∂qᵢ/∂γᵣ can be computed directly from equations (30a) and (30b) as described below.

Derivatives of {pₖ} and {qₖ} with Respect to the LSPs

Let γᵣ=cos(ωᵣ) be the r-th LSP. Then the polynomials P(z) and Q(z) in (30a) and (30b) can be written as:

$$\begin{matrix}P ( z ) = {\prod }_{k = 1}^{k = M / 2} ( 1 - 2 {γ}_{2 k - 1} {z}^{- 1} + {z}^{- 2} ) & ( 36 a ) \\ Q ( z ) = {\prod }_{k = 1}^{k = M / 2} ( 1 - 2 {γ}_{2 k} {z}^{- 1} + {z}^{- 2} ) & ( 36 b )\end{matrix}$$

Let Pᵣ(z) be the (M−2)^{th} degree polynomial defined by dropping the r-th factor

(1−2γ₂ᵣ₋₁z⁻¹+z⁻²)

that is:

$${P}_{r} ( z ) = 1 + {\sum }_{k - 1}^{M - 2} {p}_{kr}^{′} {z}^{- k} = {\prod }_{j = 1 , j \neq r}^{M / 2} ( 1 - 2 {γ}_{2 j - 1} {z}^{- 1} + {z}^{- 2} ) \qquad ( 37 a )$$

where p′ₖᵣ are the coefficients of Pᵣ(z) and are calculated from the right hand side of (37a) once the LSPs are known. It is easily verified from (21 a) that:

∂P(z)/∂γᵣ=−2z⁻¹Pᵣ(z) (37b)

From (37b), we see that the coefficients {p′ₖᵣ} of the polynomial Pᵣ(z) are derivatives of the coefficients {pₖ}with respect to the r^{th} LSP. More specifically:

∂pⱼ/∂γᵣ=−2p′_{j-1,r} j=1, 3 . . . (M−1) (37c)

and

∂p₀/∂γᵣ=0 (37d)

where p′₀ᵣ=1 for all r.

Similarly, let Qᵣ(z) be the (M−2)^{th} degree polynomial defined by dropping the factor (1−2γ₂ᵣz⁻¹+z⁻²)

that is:

$${Q}_{r} ( z ) = 1 + {\sum }_{k = 1}^{M - 1} {q}_{kr} {z}^{- k} = {\prod }_{j = 1 , j \neq r}^{M / 2} ( 1 - 2 {γ}_{2 j} {z}^{- 1} + {z}^{- 2} ) \qquad ( 38 a )$$

where q′ₖᵣ are the coefficients of) Qᵣ(z) and are calculated from the right hand side of (38a) once the LSPs are known. It is easily verified from (38a) that:

∂Q(z)/∂γᵣ=−2z⁻¹Qᵣ(z) (38b)

From (38b), it is shown that the coefficients {q′ₖᵣ} of the polynomial Qᵣ(z) are the derivatives of the coefficients {qₖ} with respect to the r^{th} LSP. More specifically:

∂qⱼ/∂γᵣ=−2q′_{j-1,r} j=2, 4, . . . M (38c)

and

∂q₀/∂γᵣ=0 (38d)

where q′₀ᵣ=1 for all r. At the i-th iteration, the largest step-size μᵢ of the gradient descent algorithm can be explicitly determined as:

μᵢ=max(|γⱼ₊₁−γⱼ|) j=1, 2 . . . M−1 (39)

Derivatives of the {pₖ} and {qₖ} coefficients from (37c) and (38c) can be substituted into (35b) and (35c) to compute the partial derivatives d(j, r) of the filter coefficients relative to the LSPs. The derivatives d(j,r) are then substituted into (29a) to compute the partial derivatives ∂ŝ(k)/∂γᵣ of the synthesized speech samples with respect to the LSPs. These are then substituted into (26b) to compute the gradient vector.

Minimization in the LSP domain offers several unique advantages. First, the root domain optimization described before assumes that the roots of the polynomial A(z) are distinct that is there are no repeated roots. Second, LSP interpolation at frame boundaries can be easily incorporated into the optimization. Third, sometimes finding the roots requires many iterations. Fourth, in some embodiments, LSPs are more appropriate for optimization. For example, in the root domain optimization, if the initial LPC roots are distinct real roots, the optimization cannot make them complex. With LSPs, this is possible. Fifth, LSPs can be optimized using real arithmetic. Finally, most of the state-of-the-art speech codecs such as the ITU-T G.729 and ETSI AMR standards use the line spectrum pairs (LSPs) as the final parameters for quantization and transmission purposes.

The control data for the optimal synthesis polynomial A(z) can be transmitted in a number of different formats. Most of the existing standards use LSPs as the final transmission parameters. Thus, the optimization produces the final parameters and there is no need to convert them to other sets of parameters. After the synthesis model has been completely determined, the control data for the model is quantized into digital bit stream for transmission or storage. Many different industry standards exist for quantization. Commonly, in CELP-type coders the control data are quantized into a total of 80 bits. Thus, according to this example, the synthesized speech s(n), including optimization, can be transmitted with a data rate of 8,000 bits/s (80 bits/frame÷0.010 s/frame).

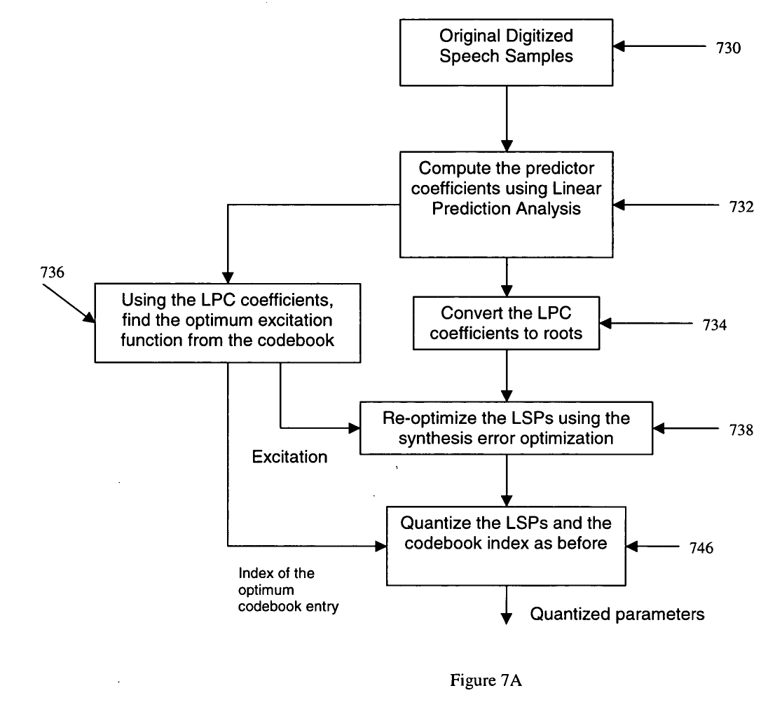

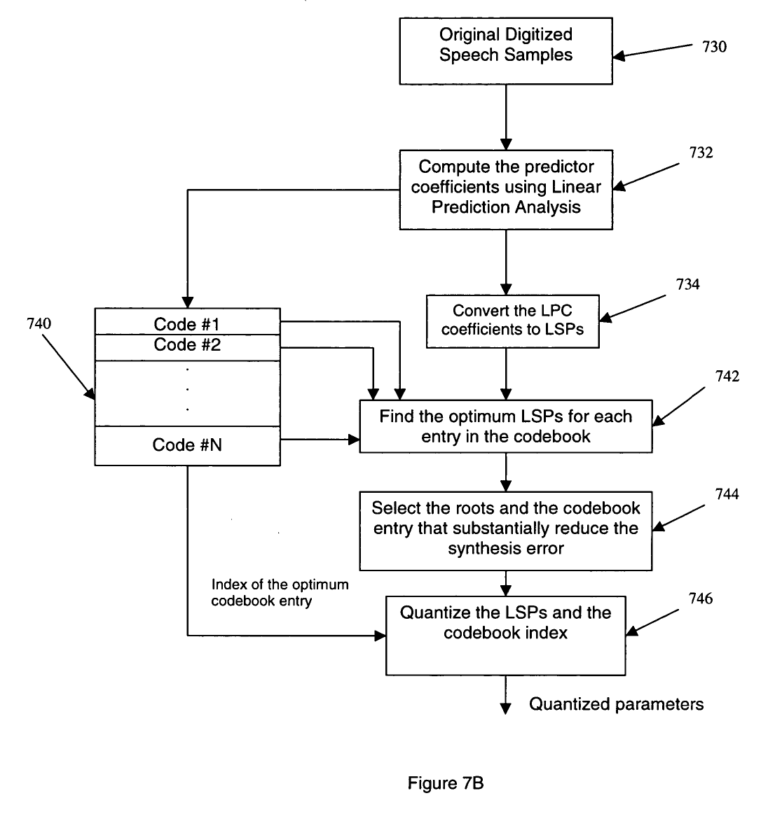

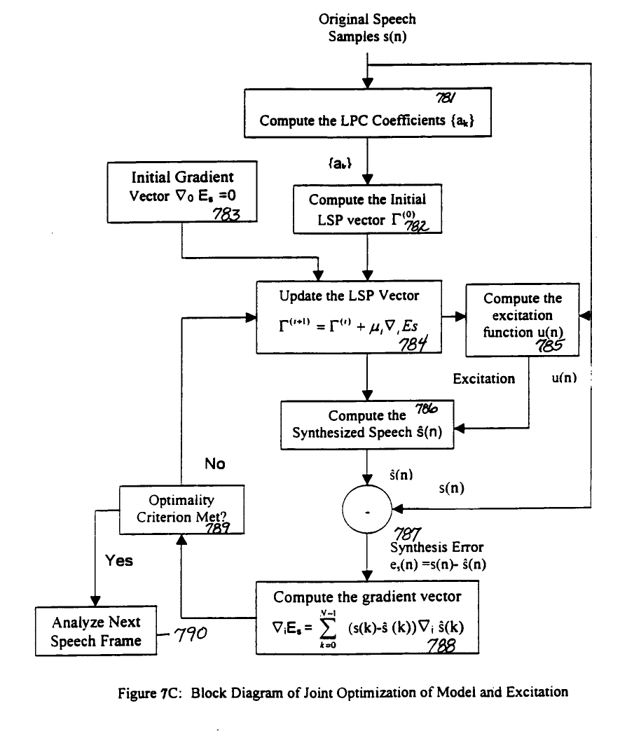

The process above is depicted in FIG. 7A. The process in FIG. 7A is performed by processing logic that may comprise hardware (e.g., circuitry, dedicated logic, etc.), software (such as is run on a general purpose computer system or a dedicated machine), or a combination of both.

Referring to FIG. 7A, processing logic begins with original digitized speech samples (processing block 730) and computes the predictor coefficients using the Linear Prediction Analysis technique described above or another comparable method (processing block 732). Then processing logic finds the optimum excitation function u(n) from a codebook using the LPC coefficients (processing block 736).

After selection of the excitation function u(n), processing logic optimizes the LPC coefficients. To make optimization of the LPC coefficients faster and to guarantee filter stability, processing logic converts the LPC coefficients a₁ . . . a_{M} to LSPs (processing block 734) and uses a gradient descent algorithm to optimize the LSPs using the synthesis error optimization (processing block 738). Once the optimal roots are found, processing logic quantizes the LSPs and the index to the codebook entry for transmission or storage (processing block 748).

As shown in FIG. 7A, as well as FIGS. 7B and 7C, the order of operations can be changed depending on the accuracy desired and the computing resources available.

In FIGS. 7B and 7C, a different encoding sequence is shown that is applicable to multipulse and CELP-type speech coders which should provide even more accurate synthesis. However, some additional computing power will be needed.

Referring to FIG. 7B, processing logic begins with original digitized speech samples (processing block 730) and computes the predictor coefficients using the Linear Prediction Analysis technique described above or another comparable method (processing block 732). Then for each frame, processing logic finds the optimum filter parameters (LSPs) for all possible excitation functions u(n) from the codebook (processing block 740).

After selection of an excitation function u(n), processing logic optimizes the predictor coefficients. To make optimization of the predictor coefficients faster and to guarantee filter stability, processing logic converts the predictor coefficients to LSPs (processing block 734), uses a gradient descent algorithm to find the optimum LSPs for each entry in the codebook (processing block 742) and selects the LSPs and the codebook entry that produces the minimum synthesis error (processing block 744). Once the optimal LSPs are found, processing logic quantizes the LSPs and the codebook index to the codebook entry for transmission or storage (processing block 746).

As mentioned above, additional encoding sequences in the LSP domain are also possible for improving the accuracy of the synthesis model depending on the computing capacity available for encoding. For example, the excitation function u(n) can be recomputed at various stages during optimization of the synthesis filter polynomial A(z).

While the optimization method shown in FIG. 7A only optimizes the parameters of the synthesis filter an additional optimization method is shown in FIG. 7C wherein both the model parameters and the excitation function are optimized. In FIG. 7A, the excitation signal u(n) is determined only once using the LPC coefficients and may be computed by using multi-pulse LPC, CELP or some other scheme. However, only the parameters of the synthesis filter are optimized to achieve the minimum synthesis error. Therefore, each iteration of the gradient descent algorithm of the optimization method uses the same excitation function, wherein the excitation function was computed before the optimization method was implemented. In contrast, the additional optimization method shown in FIG. 7C optimizes both the excitation function and the parameters of the synthesis filter model. Because both the model parameters and the excitation function are optimized, this additional optimization method is expected to produce greater optimization than the optimization method shown in FIG. 7A. As seen in FIG. 7C, the excitation function u(n) is recomputed after the LSPs have been updated at each iteration of the gradient descent algorithm.

FIG. 7C illustrates one embodiment of a process for jointly optimizing the model and excitation. The process is performed by processing logic that may comprise hardware (e.g., circuitry, dedicated logic, etc.), software (such as is run on a general purpose computer system or a dedicated machine), or a combination of both.

Referring to FIG. 7C, the process begins by processing logic using the original speech samples s(n) to compute the LPC coefficients (processing block 781). After computing the LPC coefficients, processing logic computes the initial LSP vector (processing block 782). Using the initial gradient vector (processing block 783) and the initial LSP vector, processing logic updates the LSP vector (processing block 784). Once the LSP vector has been updated, processing logic computes the excitation function u(n) using the original speech samples s(n) (processing block 785). That is, the excitation function is recomputed after the LSPs have been updated at each iteration of the gradient descent algorithm. Thereafter, using the updated LSP vector and the newly computed excitation function, processing logic computes the synthesized speech (processing block 786). Using the synthesized speech, processing logic computes the synthesis error (processing block 787). With the synthesis error, processing logic computes the gradient vector (processing block 788).

Processing logic then tests whether optimality criteria have been met (processing block 789). If optimality criteria have not been met, processing transitions to processing block 784. If optimality criteria have been met, then processing transitions to analyze the next speech frame (processing block 790).

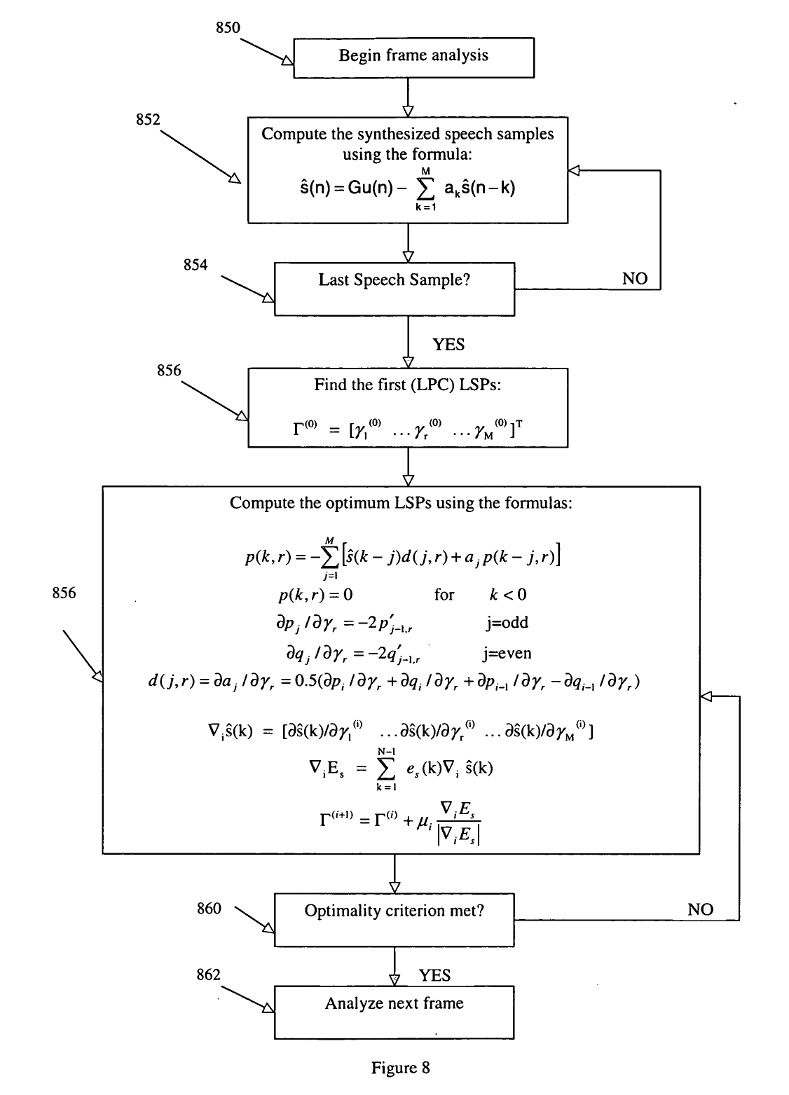

FIG. 8 shows one embodiment of a sequence of operations that requires fewer calculations to optimize the synthesis polynomial A(z) in the LSP domain. The sequence depicts the operations for one frame, and these operations are repeated for each frame of speech. The process in FIG. 8 is performed by processing logic that may comprise hardware (e.g., circuitry, dedicated logic, etc.), software (such as is run on a general purpose computer system or a dedicated machine), or a combination of both.

Referring to FIG. 8, processing logic begins frame analysis by computing the synthesized speech s(n) for each sample in the frame using formula (3) above (processing block 852). Processing logic checks whether the current sample being processed is the last sample (processing block 854). If not, processing transitions to processing block 852. Note that the computation of the synthesized speech is repeated until the last sample in the frame has been computed. If it is, then processing transitions to processing block 856.

At processing block 856, processing logic computes the first (LPC) LSPs. Next, processing logic optimizes the LSPs with an iterative gradient descent algorithm using formulas (38c), (38d), (37c), (37d), (35b), (35c), (26a), (26b) and (25a) described above (processing block 856).

Processing logic tests whether the optimality criterion is met (processing block 860) as iterations are repeated until a completion criteria is met, for example if an iteration limit has been reached. If not, then processing transitions back to processing block 856. If so, then processing proceeds to analyze the next frame, if any (processing block 862).

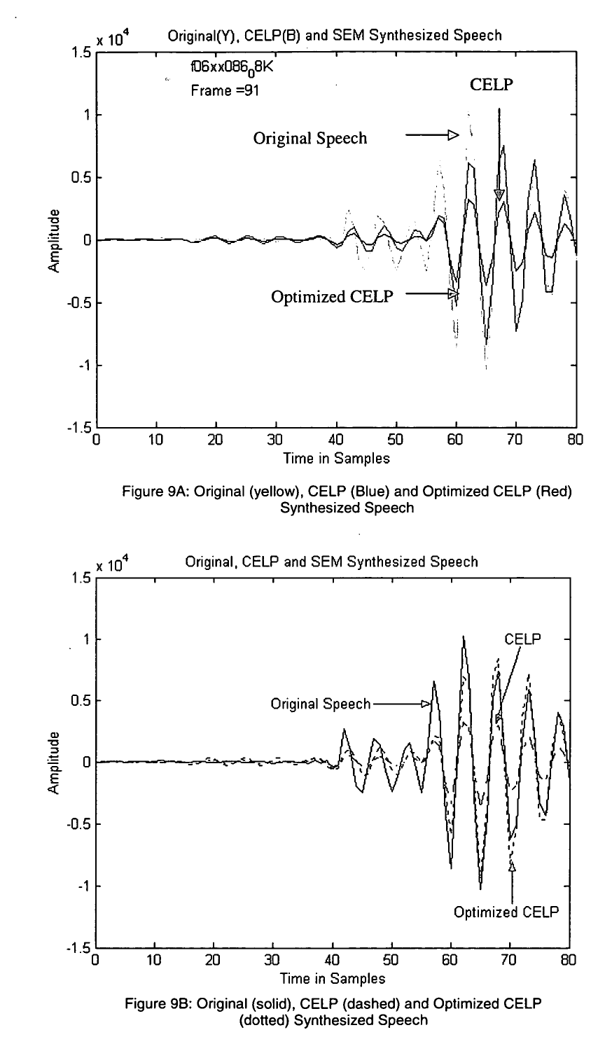

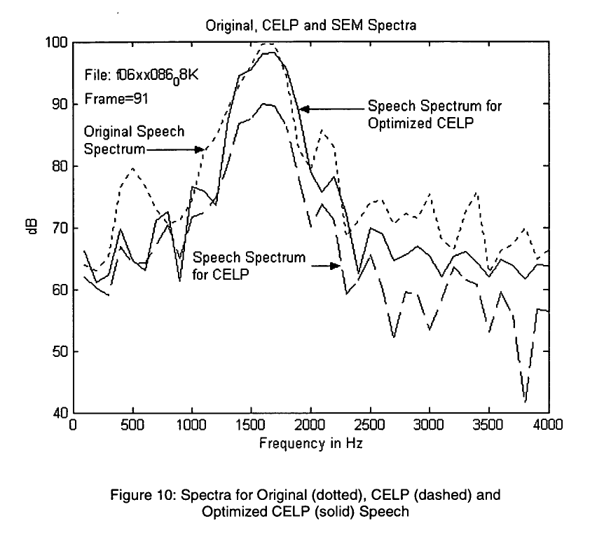

FIGS. 9A, 9B, and 10 show the results provided by the new optimization algorithm. These figures show several different comparisons between a prior art CELP synthesis system and the optimized synthesis system. The speech sample used for this comparison is a segment of a voiced part of letter “C.” In FIGS. 9A and 9B a timeline-amplitude chart of the original speech, a prior art CELP synthesized speech and the optimized synthesized speech is shown. As can be seen, the optimally synthesized speech matches the original speech much closer than the non-optimal (LPC) synthesized speech.

FIG. 10 shows a spectral chart of the original speech, the CELP synthesized speech and the optimally synthesized speech. The main spectral peak of the original speech can be seen in this chart at a frequency of about 1600 Hz. Accordingly, the spectrum of the optimized synthesized speech waveform matches the 1600 Hz component of the original speech spectrum much better than the LPC synthesized speech waveform.

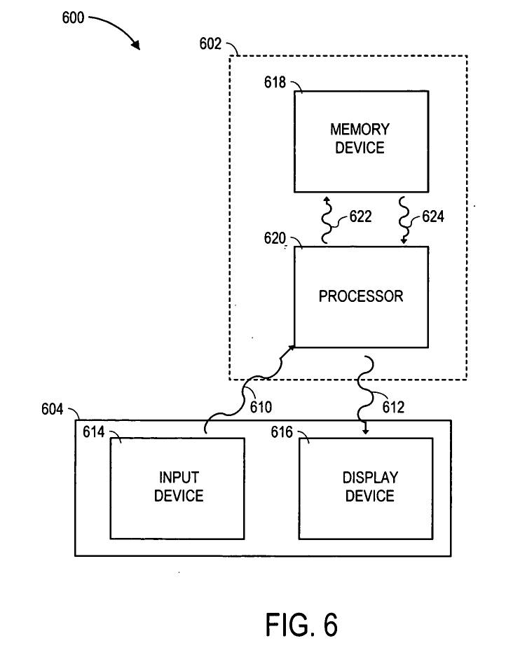

All the methods described herein for optimizing the model and/or the excitation function (“optimization methods”) may be implemented in an excitation function and model optimization device (“optimization device”) as shown in FIG. 6 and indicated as reference number 600. Optimization device 600 generally includes an optimization unit 602 and may also include an interface unit 604.

Optimization unit 602 includes a processor 620 coupled to a memory device 618. Memory device 618 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information.

Processor 620 may be any type of apparatus used to process digital information. Memory device 618 stores the speech signal, and at least one of the optimization methods. Upon the relevant request from processor 620 via a processor signal 622, the memory communicates at least one of the optimization methods and the speech signal (or portions thereof) via a memory signal 624 to processor 620. Processor 620 then performs the optimization method.

Interface unit 604 generally includes an input device 614 and an output device 616. Output device 616 is any type of visual, manual, audio, electronic or electromagnetic device capable of communicating information from a processor or memory to a person or other processor or memory. Examples of display devices include, but are not limited to, monitors, speakers, liquid crystal displays, networks, buses, and interfaces.

Input device 614 is any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 614 and 616, respectively, may be included in a single device such as a touch screen, computer, processor or memory coupled to the processor via a network.

The speech signal may be communicated to memory device 618 from input device 614 through processor 620. Additionally, the optimized model and/or excitation function may be communicated from processor 620 to display device 616.

Implementations and embodiments of the optimization methods include computer readable software code. These methods may be implemented together or independently. Such code may be stored on a processor, a memory device or on any other computer readable storage medium. Alternatively, the software code may be encoded in a computer readable electronic or optical signal. The code may be object code or any other code describing or controlling the functionality described herein. The computer readable storage medium may be a magnetic storage disk such as a floppy disk, an optical disk such as a CD-ROM, semiconductor memory or any other physical object storing program code or associated data.

Although the methods and apparatuses disclosed herein have been described in terms of specific embodiments and applications, it should be understood that the invention is not so limited, and modifications may be made without departing from the invention. The scope of the invention is defined by the appended claims, and all of the devices that come within the meaning of the claims, either literally or by equivalence, are intended to be embraced therein.

We claim:

1. A method comprising:
generating synthesized speech samples, using a synthesis filter, in response to an excitation signal;
determining a synthesis error between original speech samples and the synthesized speech samples; and
substantially reducing the synthesis error by computing both the excitation signal and filter parameters for the synthesis filter, wherein substantially reducing the synthesis error comprises applying a gradient descent algorithm to a polynomial representing the synthesis error over a series of iterations, including computing a gradient of the synthesis error in terms of gradient vectors of the synthesized speech samples by generating partial derivatives, using a recursive algorithm, for terms of a polynomial representing the synthesized speech samples over a series of iterations.

2. The method defined in claim 1 wherein substantially reducing the synthesis error occurs in the root domain and the gradient descent algorithm is applied to roots of the polynomial.

3. The method defined in claim 1 wherein substantially reducing the synthesis error comprises finding the roots of the polynomial representing the synthesis error.

4. The method defined in claim 3 wherein finding the roots of a polynomial representing the synthesis error comprises converting linear predictive coding (LPC) coefficients to roots.

5. The method defined in claim 1 wherein reducing the synthesis error between original speech samples and the synthesized speech samples occurs in the line spectrum pair (LSP) or the line spectrum frequency (LSF) domain, and generating partial derivatives, using a recursive algorithm, for terms of the polynomial representing the synthesized speech samples comprises computing partial derivatives with respect to line spectrum pairs (LSPs).

6. The method defined in claim 5 wherein the LSPs comprise roots of a pair of polynomials based on line spectrum frequencies (LSFs).

7. The method defined in claim 5 further comprising using gradient descent to optimize LSPs for the excitation signal to reduce an error between the original speech samples and the synthesized speech samples.

8. The method defined in claim 5 wherein substantially reducing the synthesis error comprises finding the LSPs of the polynomial representing the synthesis error.

9. The method defined in claim 1 further comprising adjusting a step-size used in the gradient descent algorithm at each iteration to ensure that a minimum of the synthesis error is not overshot.

10. The method defined in claim 9 further comprising repeating use of a previous parameter vector from a previous iteration using a smaller step size if use of the current parameter vector from the current iteration causes the synthesis filter to become unstable or the synthesis error resulting from use of the current parameter vector is greater than the synthesis error resulting from use of the previous parameter vector.

11. The method defined in claim 10 wherein adjusting the step-size continues until the synthesis filter regains stability or the synthesis error of the current iteration becomes smaller than the synthesis error of the previous iteration.

12. The method defined in claim 1 further comprising generating an excitation function.

13. The method defined in claim 12 wherein generating an excitation function comprises selecting the excitation function from a codebook of possible excitations.

14. An apparatus comprising:
an excitation unit to generate an excitation signal;
a synthesis filter to generate synthesized speech samples in response to the excitation signal;
a synthesis error generator to determine a synthesis error between original speech samples and the synthesized speech samples; and
a synthesis filter and excitation unit parameter generator to compute both the excitation signal and filter parameters for the synthesis filter in order to substantially reduce the synthesis error, wherein the synthesis filter and excitation unit parameter generator substantially reduces the synthesis error by applying a gradient descent algorithm to a polynomial representing the synthesis error over a series of iterations, including computing a gradient of the synthesis error in terms of gradient vectors of the synthesized speech samples by generating partial derivatives, using a recursive algorithm, for terms of a polynomial representing the synthesized speech samples over a series of iterations.

15. The apparatus defined in claim 14 wherein the synthesis filter and excitation unit parameter generator substantially reduces the synthesis error in the root domain and the gradient descent algorithm is applied to roots of the polynomial.

16. The apparatus defined in claim 14 wherein the synthesis filter and excitation unit parameter generator substantially reduces the synthesis error by finding the roots of the polynomial representing the synthesis error.

17. The apparatus defined in claim 16 wherein the synthesis filter and excitation unit parameter generator finds the roots of the polynomial representing the synthesis error by converting linear predictive coding (LPC) coefficients to roots.

18. The apparatus defined in claim 14 wherein the synthesis filter and excitation unit parameter generator reduces the synthesis error between original speech samples and the synthesized speech samples occurring in the line spectrum pair (LSP) domain, and generates partial derivatives, using a recursive algorithm, for terms of the polynomial representing the synthesized speech samples comprises computing partial derivatives with respect to line spectrum pairs (LSPs).

19. The apparatus defined in claim 18 wherein the LSPs comprise roots of a pair of polynomials based on line spectrum frequencies (LSFs).

20. The apparatus defined in claim 18 wherein the synthesis filter and excitation unit parameter generator uses gradient descent to optimize LSPs for the excitation signal to reduce an error between the original speech samples and the synthesized speech samples.

21. The apparatus defined in claim 18 wherein the synthesis filter and excitation unit parameter generator substantially reduces the synthesis error by finding the LSPs of the polynomial representing the synthesis error.

22. The apparatus defined in claim 14 wherein the synthesis filter and excitation unit parameter generator adjusts a step-size used in the gradient descent algorithm at each iteration to ensure that a minimum of the synthesis error is not overshot.

23. The apparatus defined in claim 22 wherein the synthesis filter and excitation unit parameter generator repeats use of a previous parameter vector from a previous iteration using a smaller step size if use of the current parameter vector from the current iteration causes the synthesis filter to become unstable or the synthesis error resulting from use of the current parameter vector is greater than the synthesis error resulting from use of the previous parameter vector.

24. The apparatus defined in claim 14 wherein the excitation unit generates an excitation signal by selecting an excitation function from a codebook of possible excitations.

25. An article of manufacture having one or more recordable media storing instructions which, when executed by a system, cause the system to:
generate synthesized speech samples, using a synthesis filter, in response to an excitation signal;
determine a synthesis error between original speech samples and the synthesized speech samples; and
substantially reduce the synthesis error to compute both the excitation signal and filter parameters for the synthesis filter, wherein the instructions to substantially reduce the synthesis error comprise instruction which, when executed by a system, cause the system to apply a gradient descent algorithm to a polynomial representing the synthesis error over a series of iteration, including computing a gradient of the synthesis error in terms of gradient vectors of the synthesized speech samples by generating partial derivatives, using a recursive algorithm, for terms of a polynomial representing the synthesized speech samples over a series of iterations.

26. The article of manufacture defined in claim 25 wherein the substantial reduction in the synthesis error occurs in the root domain and the gradient descent algorithm is applied to roots of the polynomial.

27. The article of manufacture defined in claim 25 wherein the instructions to substantially reduce the synthesis error comprise instructions which, when executed by a system, cause the system to find the roots of the polynomial representing the synthesis error by converting linear predictive coding (LPC) coefficients to roots.

28. The article of manufacture defined in claim 27 wherein the instructions to generate partial derivatives, using a recursive algorithm, for terms of the polynomial representing the synthesized speech samples over a series of iterations comprises instructions which, when executed by a system, cause the system to generate the partial derivatives for each root of a polynomial representing the synthesized speech samples during an iteration in the series of iterations.

29. The article of manufacture defined in claim 25 wherein reduction of the synthesis error between original speech samples and the synthesized speech samples occurs in the line spectrum pair (LSP) domain, and instructions to generate partial derivatives, using a recursive algorithm, for terms of the polynomial representing the synthesized speech samples comprise instructions which, when executed by a system, cause the system to compute partial derivatives with respect to line spectrum pairs (LSPs).

30. The article of manufacture defined in claim 29 wherein the LSPs comprise roots of a pair of polynomials based on line spectrum frequencies (LSFs).

31. The article of manufacture defined in claim 30 wherein instructions to substantially reduce the synthesis error comprises instructions which, when executed by a system, cause the system to find the LSPs of the polynomial representing the synthesis error.

32. The article of manufacture defined in claim 31 wherein instructions to compute the gradient vector comprise instructions which, when executed by a system, cause the system to compute the gradient vector of the synthesis error relative to LSP vectors.

33. The article of manufacture defined in claim 32 wherein instructions to generate partial derivatives, using a recursive algorithm, for terms of the polynomial representing the synthesized speech samples over a series of iterations comprise instructions which, when executed by a system, cause the system to generate the partial derivatives for each LSP of a polynomial representing the synthesized speech samples during an iteration in the series of iterations.
